(19) United States
(12) Patent Application Publication
(10) Pub. No.: US 2023/0052704 A1
(43) Pub. Date: Feb. 16, 2023

(54) POSITIVE ELECTRODE FOR SECONDARY BATTERY, AND SECONDARY BATTERY

(71) Applicant: MURATA MANUFACTURING CO., LTD., Kyoto (JP)

(72) Inventors: Takamasa ONO, Kyoto (JP); Atsushi OUKI, Kyoto (JP); Masaki KURATSUKA, Kyoto (JP); Takashige FUJIKAWA, Kyoto (JP); Ryuji SOEDA, Kyoto (JP); Sho TAKAHASHI, Kyoto (JP); Yoshihito AKIYAMA, Kyoto (JP); Yosuke KONO, Kyoto (JP); Shoichi NISHIYAMA, Kyoto (JP); Takeo ASANUMA, Kyoto (JP); Shinji HAYAZAKI, Kyoto (JP)

(21) Appl. No.: 17/970,030

(22) Filed: Oct. 20, 2022

Related U.S. Application Data
(63) Continuation of application No. PCT/JP2021/014724, filed on Apr. 7, 2021.

(30) Foreign Application Priority Data
Apr. 28, 2020 (JP) 2020-078955
Aug. 4, 2020 (JP) 2020-132277

(51) Int. Cl. H01M 4/525; H01M 4/505; H01M 50/105; H01M 50/136; H01M 10/0567; H01M 10/0525; C01G 53/00; H01G 11/50; H01G 11/58

(52) U.S. Cl. CPC H01M 4/525; H01M 4/505; H01M 50/105; H01M 50/136; H01M 10/0567; H01M 10/0525; C01G 53/50; H01G 11/50; H01G 11/58; H01M 2004/028

(57) ABSTRACT

A secondary battery includes a positive electrode, a negative electrode, and an electrolytic solution. The positive electrode includes a positive electrode active material layer. The positive electrode active material layer includes a lithium-nickel composite oxide of a layered rock-salt type.

### CROSS REFERENCE TO RELATED APPLICATIONS

The present application is a continuation of PCT patent application no. PCT/JP2021/014724, filed on Apr. 7, 2021, which claims priority to Japanese patent application nos. JP2020-078955 and JP2020-132277, filed on Apr. 28, 2020 and Aug. 4, 2020, respectively, the entire contents of which are incorporated herein by reference.

### BACKGROUND

The present technology relates to a positive electrode for a secondary battery, and a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode (a positive electrode for a secondary battery), a negative electrode, and an electrolytic solution. A configuration of the secondary battery has been considered in various ways.

Specifically, in order to obtain a superior characteristic such as superior thermal stability, a layer including LiAlO₂ is provided on a surface of a lithium-transition-metal composite oxide particle, and Al derived from LiAlO₂ is present in a solid solution state in the vicinity of the surface of the lithium-transition-metal composite oxide particle.

### SUMMARY

The present application relates to a positive electrode for a secondary battery, and a secondary battery.

Although consideration has been given in various ways to improve a battery characteristic of a secondary battery, the secondary battery has not yet achieved a sufficient battery characteristic, and there is still room for improvement in terms thereof.

The present technology has been made in view of such an issue, and relates to providing a positive electrode for a secondary battery, and a secondary battery that are each able to achieve a superior battery characteristic according to an embodiment.

A positive electrode for a secondary battery according to an embodiment of the present technology includes a positive electrode active material layer. The positive electrode active material layer includes a lithium-nickel composite oxide of a layered rock-salt type represented by Formula (1) below. According to an analysis of the positive electrode active material layer performed at a surface of the positive electrode active material layer by X-ray photoelectron spectroscopy, a ratio X of an atomic concentration of Al to an atomic concentration of Ni satisfies a condition represented by Expression (2) below. According to an analysis of the positive electrode active material layer performed at an inner part at a depth of 100 nanometers of the positive electrode active material layer by X-ray photoelectron spectroscopy, a ratio Y of the atomic concentration of Al to the atomic concentration of Ni satisfies a condition represented by Expression (3) below. A ratio Z of the ratio X to the ratio Y satisfies a condition represented by Expression (4) below.

LiₐNi_{1-b-c-d}Co_{b}Al_{c}M_{d}Oₑ (1)

where:
M is at least one of Fe, Mn, Cu, Zn, Cr, V, Ti, Mg, or Zr; and
a, b, c, d, and e satisfy 0.8<a<1.2, 0.06≤b≤0.18, 0.015≤c≤0.05, 0≤d≤0.08, 0<e<3, 0.1≤(b+c+d)≤0.22, and 4.33≤(1-b-c-d)/b≤15.0.

0.30≤X≤0.70 (2)

0.16≤Y≤0.37 (3)

1.30≤Z≤2.52 (4)

A secondary battery according to an embodiment of the present technology includes a positive electrode, a negative electrode, and an electrolytic solution. The positive electrode has a configuration similar to that of the positive electrode for a secondary battery according to an embodiment of the present technology described above.

Descriptions will be given later as to details of a procedure of analyzing the positive electrode active material layer (a procedure of identifying each of the ratios X, Y, and Z) by X-ray photoelectron spectroscopy.

According to the positive electrode for a secondary battery of an embodiment of the present technology, or the secondary battery of an embodiment of the present technology, the positive electrode active material layer includes the lithium-nickel composite oxide of the layered rock-salt type described above, and the series of conditions described above are satisfied regarding an analysis result (the ratios X, Y, and Z) on the positive electrode active material layer obtained by X-ray photoelectron spectroscopy. Accordingly, it is possible to obtain a superior battery characteristic.

Note that effects of the present technology are not necessarily limited to those described herein and may include any of a series of suitable effects in relation to the present technology.

### BRIEF DESCRIPTION OF THE FIGURES

FIG. 1 is a perspective view of a configuration of a secondary battery according to an embodiment of the present technology.

FIG. 2 is a sectional view of a configuration of a battery device illustrated in FIG. 1.

FIG. 3 is an enlarged sectional view of a configuration of a positive electrode illustrated in FIG. 2.

FIG. 4 is a block diagram illustrating a configuration of an application example of the secondary battery.

### DETAILED DESCRIPTION

One or embodiments of the present technology are described below in further detail including with reference to the drawings.

A description is given first of a secondary battery according to an embodiment of the present technology. A positive electrode for a secondary battery according to an embodiment of the present technology is a portion or a component of the secondary battery, and is thus described together below. Hereinafter, the positive electrode for a secondary battery is simply referred to as a “positive electrode”.

The secondary battery to be described herein is a secondary battery that obtains a battery capacity using insertion and extraction of an electrode reactant, and includes a positive electrode, a negative electrode, and an electrolytic solution. The electrolytic solution is a liquid electrolyte. In the secondary battery, to prevent precipitation of the electrode reactant on a surface of the negative electrode during charging, a charge capacity of the negative electrode is greater than a discharge capacity of the positive electrode. In other words, an electrochemical capacity per unit area of the negative electrode is set to be greater than an electrochemical capacity per unit area of the positive electrode.

The electrode reactant is not limited to a particular kind, and may specifically be a light metal such as an alkali metal or an alkaline earth metal. Examples of the alkali metal include lithium, sodium, and potassium, and examples of the alkaline earth metal include beryllium, magnesium, and calcium.

In the following, a description is given of an example case where the electrode reactant is lithium. A secondary battery that obtains a battery capacity using insertion and extraction of lithium is a so-called lithium-ion secondary battery. In the lithium-ion secondary battery, lithium is inserted and extracted in an ionic state.

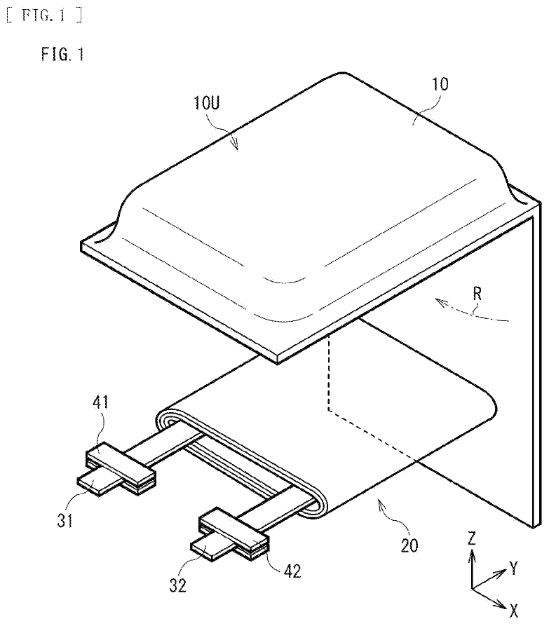

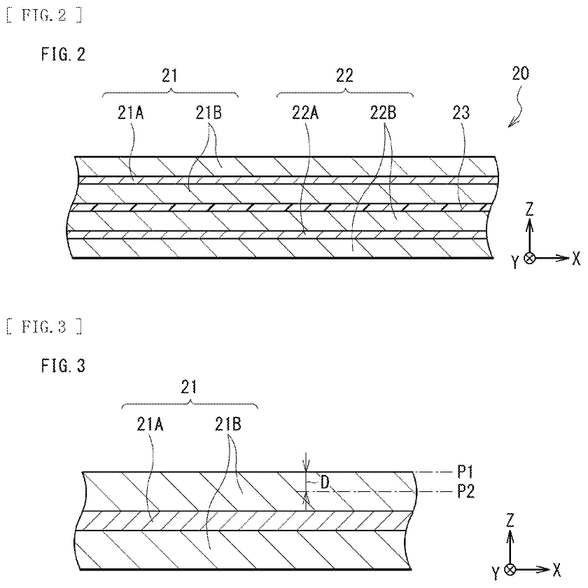

FIG. 1 illustrates a perspective configuration of the secondary battery. FIG. 2 illustrates a sectional configuration of a battery device 20 illustrated in FIG. 1. Note that FIG. 1 illustrates a state in which an outer package film 10 and the battery device 20 are separated away from each other. FIG. 2 illustrates only a portion of the battery device 20.

As illustrated in FIGS. 1 and 2, the secondary battery includes the outer package film 10, the battery device 20, a positive electrode lead 31 and a negative electrode lead 32, and sealing films 41 and 42. The secondary battery described here is a secondary battery of a laminated-film type in which an outer package member having flexibility or softness, that is, the outer package film 10, is used as an outer package member to contain the battery device 20.

As illustrated in FIG. 1, the outer package film 10 is a flexible outer package member to contain the battery device 20, that is, for example, a positive electrode 21, a negative electrode 22, and an electrolytic solution to be described later. The outer package film 10 has a pouch-shaped structure.

Here, the outer package film 10 is a single film member, and is foldable in a folding direction R. The outer package film 10 has a depression part 10U. The depression part 10U is a so-called deep drawn part in which the battery device 20 is to be placed.

The outer package film 10 is not particularly limited in configuration such as the material or the number of layers. The outer package film 10 may thus be a single-layered film or a multilayered film.

Here, the outer package film 10 is a three-layered laminated film including a fusion-bonding layer, a metal layer, and a surface protective layer that are stacked in this order from an inner side. The fusion-bonding layer includes a polymer compound such as polypropylene. The metal layer includes a metal material such as aluminum. The surface protective layer includes a polymer compound such as nylon. In a state where the outer package film 10 is folded, outer edges of the outer package film 10 (the fusion-bonding layer) opposed to each other are fusion-bonded to each other.

As illustrated in FIG. 1, each of the sealing films 41 and 42 is a sealing member for preventing entry of, for example, outside air into the inside of the outer package film 10. The sealing film 41 is interposed between the outer package film 10 and the positive electrode lead 31, and the sealing film 42 is interposed between the outer package film 10 and the negative electrode lead 32. The sealing film 41, the sealing film 42, or both may be omitted, however.

Specifically, the sealing film 41 includes a polymer compound, such as polyolefin, that has adherence to the positive electrode lead 31. Examples of the polyolefin include polypropylene.

The sealing film 42 has a configuration similar to that of the sealing film 41 except that the sealing film 42 has adherence to the negative electrode lead 32. Thus, the sealing film 42 includes a polymer compound, such as polyolefin, that has adherence to the negative electrode lead 32.

As illustrated in FIGS. 1 and 2, the battery device 20 is a power generation device contained inside the outer package film 10, and includes the positive electrode 21, the negative electrode 22, a separator 23, and the electrolytic solution. The electrolytic solution is not illustrated.

Here, the battery device 20 is a so-called wound electrode body. Thus, in the battery device 20, the positive electrode 21 and the negative electrode 22 are stacked on each other with the separator 23 interposed therebetween, and the stack of the positive electrode 21, the negative electrode 22, and the separator 23 is wound about a winding axis. The winding axis is a virtual axis extending in a Y-axis direction. In other words, the positive electrode 21 and the negative electrode 22 are wound while being opposed to each other with the separator 23 interposed therebetween.

The battery device 20 has an elongated three-dimensional shape. A section of the battery device 20 intersecting the winding axis, that is, a section of the battery device 20 along an XZ plane, thus has an elongated shape defined by a major axis and a minor axis. The major axis is a virtual axis that extends in an X-axis direction and has a larger length than the minor axis. The minor axis is a virtual axis that extends in a Z-axis direction intersecting the X-axis direction and has a smaller length than the major axis. Here, the section of the battery device 20 has an elongated, generally elliptical shape.

The positive electrode 21 is the positive electrode for a secondary battery according to an embodiment of the present technology. As illustrated in FIG. 2, the positive electrode 21 includes a positive electrode active material layer 21B. Here, the positive electrode 21 includes a positive electrode current collector 21A together with the positive electrode active material layer 21B. The positive electrode current collector 21A supports the positive electrode active material layer 21B.

The positive electrode current collector 21A has two opposed surfaces on each of which the positive electrode active material layer 21B is disposed. The positive electrode current collector 21A includes an electrically conductive material such as a metal material. Examples of the metal material include aluminum.

The positive electrode active material layer 21B includes a positive electrode active material into which lithium is insertable and from which lithium is extractable. Here, the positive electrode active material layer 21B is disposed on each of the two opposed surfaces of the positive electrode current collector 21A. Note that the positive electrode active material layer 21B may further include, for example, a positive electrode binder and a positive electrode conductor, and may be disposed only on one of the two opposed surfaces of the positive electrode current collector 21A. A method of forming the positive electrode active material layer 21B is not particularly limited. Specific examples of the method of forming the positive electrode active material layer 21B include a coating method.

Specifically, the positive electrode active material layer 21B includes, as the positive electrode active material, one or more of lithium-nickel composite oxides of a layered rock-salt type represented by Formula (1) below. A reason for this is that a high energy density is obtainable.

LiₐNi_{1-b-c-d}Co_{b}Al_{c}M_{d}Oₑ (1)

where:
M is at least one of Fe, Mn, Cu, Zn, Cr, V, Ti, Mg, or Zr; and
a, b, c, d, and e satisfy 0.8<a<1.2, 0.06≤b≤0.18, 0.015≤c≤0.05, 0≤d≤0.08, 0<e<3, 0.1≤(b+c+d)≤0.22, and 4.33≤(1-b-c-d)/b≤15.0.

As is apparent from the conditions related to a to e indicated in Formula (1), the lithium-nickel composite oxide is a composite oxide including Li, Ni, Co, and Al as constituent elements, and has a crystal structure of the layered rock-salt type. In other words, the lithium-nickel composite oxide includes two transition metal elements (Ni and Co) as constituent elements.

Note that, as is apparent from a possible value range of d (0≤d≤0.08), the lithium-nickel composite oxide may further include an additional element M as a constituent element. The additional element M is not particularly limited in kind, as long as the additional element M includes one or more of Fe, Mn, Cu, Zn, Cr, V, Ti, Mg, or Zr described above.

In particular, as is apparent from a possible value range of (b+c+d), that is, (0.1≤(b+c+d)≤0.22), a possible value range of (1-b-c-d) is the following range: 0.78≤(1-b-c-d)≤0.9. Accordingly, the lithium-nickel composite oxide includes, as a main component, Ni out of the two transition metal elements (Ni and Co). A reason for this is that a high energy density is obtainable.

Further, in the lithium-nickel composite oxide including the two transition metal elements (Ni and Co) as constituent elements, as is apparent from a possible value range of (1-b-c-d)/b, that is, (4.33≤(1-b-c-d)/b≤15.0), a molar ratio (1-b-c-d) of Ni is sufficiently large relative to a molar ratio (b) of Co. In other words, a ratio of the molar ratio of Ni to the molar ratio of Co (an NC ratio=(1-b-c-d)/b) is sufficiently large within an appropriate range. A reason for this is that the discharge capacity is prevented from easily decreasing even upon repeated charging and discharging, while the energy density is secured. Note that the value of the NC ratio is rounded off to two decimal places.

Here, a molar ratio (d) of the additional element M satisfies d≥0; thus, the lithium-nickel composite oxide may include the additional element M as a constituent element, or may include no additional element M as a constituent element. In particular, d preferably satisfies d>0, and the lithium-nickel composite oxide thus preferably includes the additional element M as a constituent element. A reason for this is that it becomes easier for lithium ions to smoothly enter and exit the positive electrode active material (the lithium-nickel composite oxide) at the time of charging and discharging.

A specific composition of the lithium-nickel composite oxide is not particularly limited as long as the conditions indicated in Formula (1) are satisfied. The specific composition of the lithium-nickel composite oxide will be described in detail later in Examples.

The positive electrode active material may further include one or more of lithium compounds together with the lithium-nickel composite oxide described above. Note that the lithium-nickel composite oxide described above is excluded from the lithium compound to be described here.

The term “lithium compound” is a generic term for a compound that includes lithium as a constituent element, and more specifically, a compound that includes lithium and one or more transition metal elements as constituent elements. The lithium compound is not particularly limited in kind, and is specifically, for example, an oxide, a phosphoric acid compound, a silicic acid compound, or a boric acid compound. Specific examples of the oxide include LiNiO₂, LiCoO₂, and LiMn₂O₄. Specific examples of the phosphoric acid compound include LiFePO₄ and LiMnPO₄.

The positive electrode binder includes one or more of materials including, without limitation, a synthetic rubber and a polymer compound. Examples of the synthetic rubber include a styrene-butadiene-based rubber. Examples of the polymer compound include polyvinylidene difluoride. The positive electrode conductor includes one or more of electrically conductive materials including, without limitation, a carbon material. Examples of the carbon material include graphite, carbon black, acetylene black, and Ketjen black. The electrically conductive material may be, for example, a metal material or a polymer compound.

Here, regarding a physical property of the positive electrode 21 (the positive electrode active material layer 21B) including the positive electrode active material (the lithium-nickel composite oxide), predetermined physical property conditions are satisfied in order to improve a battery characteristic of the secondary battery. Details of the physical property conditions will be described later.

As illustrated in FIG. 2, the negative electrode 22 includes a negative electrode current collector 22A and a negative electrode active material layer 22B.

The negative electrode current collector 22A has two opposed surfaces on each of which the negative electrode active material layer 22B is disposed. The negative electrode current collector 22A includes an electrically conductive material such as a metal material. Examples of the metal material include copper.

The negative electrode active material layer 22B includes one or more of negative electrode active materials into which lithium is insertable and from which lithium is extractable. Here, the negative electrode active material layer 22B is disposed on each of the two opposed surfaces of the negative electrode current collector 22A. Note that the negative electrode active material layer 22B may further include, for example, a negative electrode binder and a negative electrode conductor, and may be disposed only on one of the two opposed surfaces of the negative electrode current collector 22A. Respective details of the negative electrode binder and the negative electrode conductor are similar to the respective details of the positive electrode binder and the positive electrode conductor. A method of forming the negative electrode active material layer 22B is not particularly limited, and specifically includes one or more of methods including, without limitation, a coating method, a vapor-phase method, a liquid-phase method, a thermal spraying method, and a firing (sintering) method.

Examples of the negative electrode active material include a carbon material and a metal-based material. A reason for this is that a high energy density is obtainable. Examples of the carbon material include graphitizable carbon, non-graphitizable carbon, and graphite (natural graphite and artificial graphite). The term “metal-based material” is a generic term for a material that includes, as a constituent element or constituent elements, one or more elements among metal elements and metalloid elements that are each able to form an alloy with lithium. Examples of the metal elements and metalloid elements include silicon and tin. The metal-based material may be a simple substance, an alloy, a compound, a mixture of two or more thereof, or a material including two or more phases thereof. Specific examples of the metal-based material include TiSi₂ and SiOₓ (0<x≤2, or 0.2<x<1.4).

The separator 23 is an insulating porous film interposed between the positive electrode 21 and the negative electrode 22, as illustrated in FIG. 2. The separator 23 allows lithium ions to pass therethrough while preventing contact (a short circuit) between the positive electrode 21 and the negative electrode 22. The separator 23 includes a polymer compound such as polyethylene.

The electrolytic solution includes a solvent and an electrolyte salt. The positive electrode 21, the negative electrode 22, and the separator 23 are each impregnated with the electrolytic solution.

The solvent includes one or more of non-aqueous solvents (organic solvents) including, without limitation, a carbonic-acid-ester-based compound, a carboxylic-acid-ester-based compound, and a lactone-based compound. An electrolytic solution including a non-aqueous solvent is a so-called non-aqueous electrolytic solution. The electrolyte salt includes one or more of light metal salts including, without limitation, a lithium salt.

The electrolytic solution may further include one or more additives. The additive is not limited to a particular kind. Specifically, examples of the additive include a multi-nitrile compound. Only one multi-nitrile compound may be used, or two or more multi-nitrile compounds may be used.

The term “multi-nitrile compound” is a generic term for a compound including two or more nitrile groups. A reason why the electrolytic solution includes the multi-nitrile compound as an additive is that the generation of gas caused by a decomposition reaction of the electrolytic solution is suppressed at the positive electrode 21 upon charging and discharging, and the secondary battery is thus prevented from easily swelling.

In detail, the multi-nitrile compound has the following property: While the secondary battery is subjected to an initial cycle of charging and discharging (i.e., while the secondary battery is subjected to stabilization described below), the multi-nitrile compound is hardly dissolved and remains in the electrolytic solution. In second and subsequent cycles of charging and discharging, the multi-nitrile compound gradually reacts (dissolves) while forming a film on a surface of the positive electrode 21. Thus, even if the positive electrode active material is damaged upon the second or subsequent cycle of charging and discharging, and the positive electrode active material thus comes to have a highly reactive fresh surface, the film derived from the multi-nitrile compound is formed to cover the fresh surface. This suppresses a decomposition reaction of the electrolytic solution on the fresh surface and suppresses the generation of unnecessary gas caused by the decomposition reaction of the electrolytic solution. Examples of the damage of the positive electrode active material include a breakage of the positive electrode active material and a crack in the positive electrode active material. For these reasons, the secondary battery is prevented from easily swelling even if the charging and discharging is repeated as the second or subsequent cycle of charging and discharging.

Specifically, the multi-nitrile compound includes the two or more nitrile groups and a central group to which the two or more nitrile groups are bonded. The central group is not limited to a particular kind. Specifically, the central group may be a chain hydrocarbon group, a cyclic hydrocarbon group, or a group in which one or more kinds of the chain hydrocarbon groups and one or more kinds of the cyclic hydrocarbon groups are bonded to each other.

The chain hydrocarbon group may have a straight-chain structure, or a branched structure having one or more side chains. The cyclic hydrocarbon group may include only one ring or may include two or more rings. The chain hydrocarbon group and the cyclic hydrocarbon group may each include one or more unsaturated carbon bonds (>C═C<). Further, one or more ether bonds (—O—) may be introduced into each of the chain hydrocarbon group and the cyclic hydrocarbon group.

More specifically, examples of the multi-nitrile compound include a dinitrile compound and a trinitrile compound. The dinitrile compound includes two nitrile groups, and the trinitrile compound includes three nitrile groups. The multi-nitrile compound may include four or more nitrile groups, as a matter of course.

Specific examples of the dinitrile compound include succinonitrile (carbon number of 2), glutaronitrile (carbon number of 3), adiponitrile (carbon number of 4), pimelonitrile (carbon number of 5), suberonitrile (carbon number of 6), and sebaconitrile (carbon number of 8). These specific examples of the dinitrile compounds described in series here each include a chain saturated hydrocarbon group (alkylene group) as a central group, and the carbon number in each pair of parentheses indicates the carbon number of the alkylene group.

Specific examples of the dinitrile compound include ethylene glycol bis(propionitrile) ether. The ethylene glycol bis(propionitrile) ether includes, as a central group, a chain saturated hydrocarbon group (an alkylene group) in the middle of which two ether bonds are introduced.

Specific examples of the trinitrile compound include 1,3,5-cyclohexanetricarbonitrile and 1,3,6-hexanetricarbonitrile. 1,3,5-cyclohexanetricarbonitrile includes a saturated hydrocarbon group having a cyclic structure as a central group, and 1,3,6-hexanetricarbonitrile includes a saturated hydrocarbon group having a branched structure as a central group.

In particular, it is preferable that the electrolytic solution include two or more kinds of the multi-nitrile compounds different from each other. A reason for this is that a decomposition speed of the multi-nitrile compound differs mainly depending on a carbon number of the central group (a length of the carbon chain). Using the two or more kinds of the multi-nitrile compounds different from each other in combination makes it easier to continuously form a film derived from the multi-nitrile compounds, as compared with a case where only one kind of the multi-nitrile compound is used. This stably prevents the secondary battery from easily swelling.

It is preferable that the multi-nitrile compound include the dinitrile compound, the trinitrile compound, or both. A reason for this is that the film derived from the multi-nitrile compound is easily formed, and the secondary battery is thus sufficiently prevented from easily swelling.

A content of the multi-nitrile compound in the electrolytic solution is not particularly limited. In particular, it is preferable that the content of the multi-nitrile compound in the electrolytic solution be within a range from 0.5 wt % to 3.0 wt % both inclusive. A reason for this is that the film derived from the multi-nitrile compound is easily formed, and the secondary battery is thus further prevented from easily swelling. Note that, in a case where two or more kinds of the multi-nitrile compounds different from each other are used in combination, the content of the multi-nitrile compound described above is a sum total of contents of the respective multi-nitrile compounds.

As illustrated in FIG. 1, the positive electrode lead 31 is a positive electrode terminal coupled to the battery device 20 (the positive electrode 21), and is led out from inside to outside the outer package film 10. The positive electrode lead 31 includes an electrically conductive material such as aluminum. The positive electrode lead 31 has a thin plate shape or a meshed shape, for example.

As illustrated in FIG. 1, the negative electrode lead 32 is a negative electrode terminal coupled to the battery device 20 (the negative electrode 22), and is led out from inside to outside the outer package film 10 in a direction similar to that in the case with the positive electrode 21. The negative electrode lead 32 includes an electrically conductive material such as copper. Details of a shape of the negative electrode lead 32 are similar to the details of the shape of the positive electrode lead 31.

As described above, in order to improve the battery characteristic, the secondary battery satisfies predetermined physical property conditions regarding a physical property of the positive electrode 21 (the positive electrode active material layer 21B) including the positive electrode active material (the lithium-nickel composite oxide).

Specifically, all of three conditions (physical property conditions 1 to 3) described below are satisfied regarding an analysis result on the positive electrode active material layer 21B obtained by X-ray photoelectron spectroscopy (XPS), that is, regarding the physical property of the positive electrode active material layer 21B.

Here, prior to describing the physical property conditions 1 to 3 individually, a description will be given of a premise for describing the physical property conditions 1 to 3.

FIG. 3 illustrates an enlarged sectional configuration of the positive electrode 21 illustrated in FIG. 2. Positions P1 and P2 illustrated in FIG. 3 indicate two analysis positions where the positive electrode active material layer 21B is to be analyzed by XPS. The position P1 is a position of the surface of the positive electrode active material layer 21B, where the positive electrode active material layer 21B is viewed from the surface in a depth direction (the Z-axis direction). The position P2 is a position of an inner part of the positive electrode active material layer 21B, where the positive electrode active material layer 21B is viewed from the surface in the same direction. More specifically, the position P2 is a position at a depth D of 100 nm (depth D=100 nm) from the surface of the positive electrode active material layer 21B.

As described above, the positive electrode active material layer 21B includes the lithium-nickel composite oxide of the layered rock-salt type as the positive electrode active material, and the lithium-nickel composite oxide includes Ni and Al as constituent elements.

In this case, if the positive electrode active material layer 21B is analyzed by XPS, two XPS spectra, i.e., an Ni2p3/2 spectrum and an Al2s spectrum, are detected as the analysis result. The Ni2p3/2 spectrum is an XPS spectrum derived from Ni atoms in the lithium-nickel composite oxide, and the Al2s spectrum is an XPS spectrum derived from Al atoms in the lithium-nickel composite oxide.

Thus, an atomic concentration (at %) of Ni is calculated on the basis of a spectrum intensity of the Ni2p3/2 spectrum, and an atomic concentration (at %) of Al is calculated on the basis of a spectrum intensity of the Al2s spectrum.

### (Physical Property Condition 1)

According to an analysis of the positive electrode active material layer 21B performed at the surface (the position P1) of the positive electrode active material layer 21B by XPS, a concentration ratio X (=atomic concentration of Al/atomic concentration of Ni) which is a ratio of the atomic concentration of Al to the atomic concentration of Ni satisfies a condition represented by Expression (2) below.

0.30≤X≤0.70 (2)

The concentration ratio X is a parameter indicating a magnitude relationship between an abundance of Ni atoms and an abundance of Al atoms at the position P1. At the surface (the position P1) of the positive electrode active material layer 21B, as is apparent from the condition indicated in Expression (2), the abundance of Al atoms is appropriately smaller than the abundance of Ni atoms.

### (Physical Property Condition 2)

According to an analysis of the positive electrode active material layer 21B performed at the inner part (the position P2) of the positive electrode active material layer 21B by XPS, a concentration ratio Y (=atomic concentration of Al/atomic concentration of Ni) which is a ratio of the atomic concentration of Al to the atomic concentration of Ni satisfies a condition represented by Expression (3) below.

0.16≤Y≤0.37 (3)

The concentration ratio Y is a parameter indicating a magnitude relationship between the abundance of Ni atoms and the abundance of Al atoms at the position P2. At the inner part (the position P2) of the positive electrode active material layer 21B, as is apparent from the condition indicated in Expression (3), the abundance of Al atoms is appropriately smaller than the abundance of Ni atoms. Note that, as is apparent from comparison between the physical property conditions 1 and 2, the abundance of Al atoms is appropriately larger at the surface (the position P1) than at the inner part (the position P2). To put it the other way around, the abundance of Al atoms is appropriately smaller at the inner part (the position P2) than at the surface (the position P1).

### (Physical Property Condition 3)

Regarding the concentration ratios X and Y described above, a relative ratio Z (=concentration ratio X/concentration ratio Y) which is a ratio of the concentration ratio X to the concentration ratio Y satisfies a condition represented by Expression (4) below.

1.30≤Z≤2.52 (4)

The relative ratio Z is a parameter indicating a magnitude relationship between the abundance of Al atoms at the position P1 and the abundance of Al atoms at the position P2. As is apparent from the condition indicated in Expression (4), the abundance of Al atoms gradually decreases from the surface (the position P1) toward the inner part (the position P2) in the positive electrode active material layer 21B, resulting in an appropriate concentration gradient regarding the abundance (atomic concentration) of Al atoms.

All of the physical property conditions 1 to 3 are satisfied for a reason below. This suppresses a decrease in discharge capacity and gas generation even upon repeated charging and discharging, and improves a lithium-ion entering and exiting characteristic not only at an initial cycle of charging and discharging but also at subsequent cycles of charging and discharging, while allowing for a high energy density. Details of the reason why all of the physical property conditions 1 to 3 are satisfied will be described later.

A procedure of analyzing the positive electrode active material layer 21B by XPS, that is, a procedure of identifying each of the concentration ratios X and Y and the relative ratio Z, is as described below.

First, the secondary battery is discharged, and thereafter the secondary battery is disassembled to thereby collect the positive electrode 21 (the positive electrode active material layer 21B). Thereafter, the positive electrode 21 is washed with pure water, following which the positive electrode 21 is dried. Thereafter, the positive electrode 21 is cut into a rectangular shape (10 mm×10 mm) to thereby obtain a sample for analysis.

Thereafter, the sample is analyzed by means of an XPS analyzer. In this case, PHI Quantera SXM, a scanning X-ray photoelectron spectrometer manufactured by ULVAC-PHI, Inc., is used as the XPS analyzer. Analysis conditions are as follows. Light source: monochromatic Al Kα beam (1486.6 eV); degree of vacuum: 1×10⁻⁹ Torr (=approx. 133.3×10⁻⁹ Pa); analysis range (diameter): 100 μm; analysis depth: several nanometers; and use of an electron flood gun: yes.

As a result, the Ni2p3/2 spectrum and the Al2s spectrum are each detected at the surface (the position P1) of the positive electrode active material layer 21B, and the atomic concentration (at %) of Ni and the atomic concentration (at %) of Al are each calculated. Thus, the concentration ratio X is calculated on the basis of the atomic concentration of Ni and the atomic concentration of Al.

Thereafter, the operation of calculating the concentration ratio X described above is repeated twenty times, following which an average value of the twenty concentration ratios X is calculated as a final concentration ratio X, i.e., a concentration ratio X to be used to determine whether the physical property condition 1 is satisfied. A reason for using the average value as the value of the concentration ratio X is that this improves calculation accuracy (reproducibility) of the concentration ratio X.

Thereafter, performed is an analysis procedure that is similar to the analysis procedure employed in calculating the concentration ratio X, except that the analysis depth among the analysis conditions is changed from several nanometers to 100 nm, and that the following additional analysis conditions are introduced: acceleration voltage: 1 kV; and sputtering rate: within a range from 6 nm to 7 nm both inclusive in terms of SiO₂. In this manner, the atomic concentration (at %) of Ni and the atomic concentration (at %) of Al at the inner part (the position P2) of the positive electrode active material layer 21B are each calculated. The concentration ratio Y is thus calculated on the basis of the atomic concentration of Ni and the atomic concentration of Al. In this case also, an average value is used as a final concentration ratio Y. This improves calculation accuracy (reproducibility) of the concentration ratio Y.

Lastly, the relative ratio Z is calculated on the basis of the concentration ratios X and Y. In this manner, the concentration ratios X and Y are each identified and the relative ratio Z is identified.

Upon charging the secondary battery, in the battery device 20, lithium is extracted from the positive electrode 21 and the extracted lithium is inserted into the negative electrode 22 via the electrolytic solution. Upon discharging the secondary battery, in the battery device 20, lithium is extracted from the negative electrode 22 and the extracted lithium is inserted into the positive electrode 21 via the electrolytic solution. Upon the charging and discharging, lithium is inserted and extracted in an ionic state.

The positive electrode active material (the lithium-nickel composite oxide) is manufactured, following which the secondary battery is fabricated using the positive electrode active material.

In accordance with a procedure described below, the positive electrode active material (the lithium-nickel composite oxide) is manufactured by coprecipitation and firing including a single firing process.

First, as raw materials, a Ni source (a nickel compound) and a Co source (a cobalt compound) are prepared.

The nickel compound includes one or more of compounds that each include Ni as a constituent element. Specifically, the nickel compound is, for example, an oxide, a carbonic acid salt, a sulfuric acid salt, or a hydroxide. Details of the cobalt compound are similar to the details of the nickel compound except that the cobalt compound includes Co, instead of Ni, as a constituent element.

Thereafter, a mixture of the nickel compound and the cobalt compound is put into an aqueous solvent to thereby prepare a mixture aqueous solution. The aqueous solvent is not particularly limited in kind, and specific examples thereof include pure water. The details of the kind of the aqueous solvent described here apply also to the description below. A mixture ratio between the nickel compound and the cobalt compound, that is, a molar ratio between Ni and Co, may be set to any value depending on the composition of the positive electrode active material (the lithium-nickel composite oxide) to be finally manufactured.

Thereafter, one or more of alkali compounds are added to the mixture aqueous solution. The alkali compound is not particularly limited in kind, and is specifically, for example, a hydroxide. A precipitate in a form of particles is thereby generated, i.e., coprecipitation is performed. Thus, a precursor (secondary particles of a nickel-cobalt composite coprecipitated hydroxide) for synthesizing the lithium-nickel composite oxide is obtained. In this case, as will be described in detail later in Examples, secondary particles of a bi-model design including two kinds of particles, i.e., large-sized particles and small-sized particles, may be used. Thereafter, the precursor is washed with an aqueous solvent.

Thereafter, as other raw materials, a Li source (a lithium compound) and an Al source (an aluminum compound) are prepared. In this case, a source of the additional element M (an additional compound) may further be prepared.

The lithium compound includes one or more of compounds that each include Li as a constituent element. Specifically, the lithium compound is, for example, an oxide, a carbonic acid salt, a sulfuric acid salt, or a hydroxide. Details of the aluminum compound are similar to the details of the lithium compound except that the aluminum compound includes Al, instead of Li, as a constituent element. Details of the additional compound are similar to the details of the lithium compound except that the additional compound includes the additional element M, instead of Li, as a constituent element.

Thereafter, the precursor, the lithium compound, and the aluminum compound are mixed with each other to thereby obtain a precursor mixture. In this case, the additional compound may further be mixed with, for example, the precursor to thereby obtain a precursor mixture including the additional compound. A mixture ratio between the precursor, the lithium compound, and the aluminum compound (a molar ratio between Ni, Co, Li, and Al) may be set to any values depending on the composition of the positive electrode active material (the lithium-nickel composite oxide) to be finally manufactured. The same applies to a mixture ratio of the additional compound (a molar ratio of the additional element M).

Lastly, the precursor mixture is fired in an oxygen atmosphere, i.e., firing is performed. Conditions including, without limitation, a firing temperature and a firing time, may be freely chosen. The precursor, the lithium compound, and the aluminum compound thus react with each other. In this manner, the lithium-nickel composite oxide including Li, Ni, Co, and Al as constituent elements is synthesized. The positive electrode active material (the lithium-nickel composite oxide) is thereby obtained. As a matter of course, in a case where the precursor mixture includes the additional compound, the positive electrode active material (the lithium-nickel composite oxide) that further includes the additional element M as a constituent element is obtained.

In this case, in the process of firing the precursor mixture, Al atoms in the aluminum compound are sufficiently diffused toward an inner part of the precursor. This results in the concentration gradient in which the abundance (atomic concentration) of Al atoms gradually decreases from the surface (the position P1) toward the inner part (the position P2).

In the case of manufacturing the positive electrode active material (the lithium-nickel composite oxide), it is possible to adjust each of the concentration ratios X and Y by changing a condition such as the firing temperature in firing the precursor mixture. Accordingly, it is also possible to adjust the relative ratio Z.

In accordance with the following procedure, the secondary battery is manufactured using the positive electrode active material (the lithium-nickel composite oxide) described above.

The positive electrode active material and other materials including, without limitation, the positive electrode binder and the positive electrode conductor, are mixed with each other to thereby obtain a positive electrode mixture, following which the positive electrode mixture is put into a solvent such as an organic solvent to thereby prepare a paste positive electrode mixture slurry. Thereafter, the positive electrode mixture slurry is applied on each of the two opposed surfaces of the positive electrode current collector 21A to thereby form the positive electrode active material layer 21B. The positive electrode active material layer 21B may be compression-molded by means of, for example, a roll pressing machine. In this case, the positive electrode active material layer 21B may be heated. The positive electrode active material layer 21B may be compression-molded multiple times. In this manner, the positive electrode active material layer 21B is formed on each of the two opposed surfaces of the positive electrode current collector 21A. Thus, the positive electrode 21 is fabricated.

The negative electrode 22 is fabricated in accordance with a procedure similar to the fabrication procedure for the positive electrode 21 described above. Specifically, the negative electrode active material and other materials including, without limitation, the negative electrode binder and the negative electrode conductor, are mixed with each other to thereby obtain a negative electrode mixture, following which the negative electrode mixture is put into a solvent such as an organic solvent to thereby prepare a paste negative electrode mixture slurry. Thereafter, the negative electrode mixture slurry is applied on each of the two opposed surfaces of the negative electrode current collector 22A to thereby form the negative electrode active material layer 22B. Needless to say, the negative electrode active material layer 22B may be compression-molded. In this manner, the negative electrode active material layer 22B is formed on each of the two opposed surfaces of the negative electrode current collector 22A. Thus, the negative electrode 22 is fabricated.

The electrolyte salt is put into the solvent. Thereafter, the multi-nitrile compound may further be added to the solvent. The electrolyte salt is thereby dispersed or dissolved in the solvent. As a result, the electrolytic solution is prepared.

First, the positive electrode lead 31 is coupled to the positive electrode 21 (the positive electrode current collector 21A) by a method such as a welding method, and the negative electrode lead 32 is coupled to the negative electrode 22 (the negative electrode current collector 22A) by a method such as a welding method.

Thereafter, the positive electrode 21 and the negative electrode 22 are stacked on each other with the separator 23 interposed therebetween, following which the stack of the positive electrode 21, the negative electrode 22, and the separator 23 is wound to thereby fabricate a wound body. The wound body has a configuration similar to the configuration of the battery device 20 except that the positive electrode 21, the negative electrode 22, and the separator 23 are each unimpregnated with the electrolytic solution. Thereafter, the wound body is pressed with a machine such as a pressing machine to thereby shape the wound body into an elongated shape.

Thereafter, the wound body is placed inside the depression part 10U, following which the outer package film 10 is folded to thereby cause portions of the outer package film 10 to be opposed to each other. Thereafter, outer edges of two sides of the outer package film 10 (the fusion-bonding layer) opposed to each other are fusion-bonded to each other by a method such as a thermal-fusion-bonding method. The wound body is thereby contained inside the outer package film 10 shaped like a pouch.

Lastly, the electrolytic solution is injected into the pouch-shaped outer package film 10, following which the outer edges of the remaining one side of the outer package film 10 (the fusion-bonding layer) are fusion-bonded to each other by a method such as a thermal-fusion-bonding method. In this case, the sealing film 41 is interposed between the outer package film 10 and the positive electrode lead 31, and the sealing film 42 is interposed between the outer package film 10 and the negative electrode lead 32. The wound body is thereby impregnated with the electrolytic solution. In this manner, the battery device 20, i.e., the wound electrode body, is fabricated, and the battery device 20 is sealed in the pouch-shaped outer package film 10. Thus, the secondary battery is assembled.

The secondary battery after being assembled is charged and discharged. Various conditions including, without limitation, an environment temperature, the number of times of charging and discharging (the number of cycles), and charging and discharging conditions may be freely chosen. A film is thus formed on a surface of, for example, the negative electrode 22. This electrochemically stabilizes the state of the secondary battery.

Thus, the secondary battery including the outer package film 10, that is, the secondary battery of the laminated-film type, is completed.

According to the secondary battery, the positive electrode active material layer 21B of the positive electrode 21 includes the lithium-nickel composite oxide of the layered rock-salt type as the positive electrode active material, and all of the physical property conditions 1 to 3 are satisfied regarding the analysis result (the concentration ratios X and Y and the relative ratio Z) on the positive electrode active material layer 21B obtained by XPS.

In this case, a series of actions described below is achieved on the basis of the composition of the positive electrode active material (the lithium-nickel composite oxide) and the physical property conditions 1 to 3.

Firstly, the positive electrode active material (the lithium-nickel composite oxide) includes Ni, which is a transition metal element, as a main component. This makes it possible to obtain a high energy density.

Secondly, Al included as a constituent element in the lithium-nickel composite oxide is present as a pillar not contributing to an oxidation-reduction reaction in the layered rock-salt crystal structure (a transition metal layer). Thus, Al has a property of not being involved in charging and discharging reactions while being able to suppress a change in crystal structure.

Here, because the physical property condition 1 is satisfied, an appropriate and sufficient amount of Al atoms is present at the surface (the position P1) of the positive electrode active material layer 21B. In this case, upon charging and discharging (upon insertion and extraction of lithium ions), the crystal structure of the lithium-nickel composite oxide is prevented from easily changing in the vicinity of the surface of the positive electrode active material layer 21B, which prevents the positive electrode active material layer 21B from easily swelling and contracting. Note that examples of a change in the crystal structure of the lithium-nickel composite oxide include an unintentional Li extraction phenomenon. This prevents the positive electrode active material from easily cracking upon charging and discharging, which prevents a highly reactive fresh surface from easily appearing on the positive electrode active material. The electrolytic solution is thus prevented from being easily decomposed on the fresh surface of the positive electrode active material. As a result, the discharge capacity is prevented from easily decreasing even upon repeated charging and discharging, and gas generation to be caused by the decomposition reaction of the electrolytic solution is suppressed upon charging and discharging.

In this case, even if the secondary battery is used (charged and discharged, or stored) in a high-temperature environment, in particular, the discharge capacity is sufficiently prevented from easily decreasing, and gas is sufficiently prevented from being easily generated. In addition, in the positive electrode active material, a resistive film is prevented from being easily formed as a result of the fresh surface being prevented from easily appearing, and a change in crystal structure (e.g., a structural change from a hexagonal crystal to a cubic crystal) which causes an increase in resistance is also prevented from easily occurring.

Thirdly, because the physical property condition 2 is satisfied, the abundance of Al atoms is appropriately and sufficiently smaller at the inner part (the position P2) of the positive electrode active material layer 21B than at the surface (the position P1). In this case, not only at the initial cycle of charging and discharging but also at the subsequent cycles of charging and discharging, lithium ions are able to enter and exit the positive electrode active material layer 21B more easily, without being excessively influenced by Al atoms, at an inner portion of the positive electrode active material layer 21B than in the vicinity of the surface thereof. This makes it easier for the charging and discharging reactions to proceed smoothly and sufficiently. As a result, the energy density is secured, and it becomes easier for lithium ions to be stably and sufficiently inserted and extracted upon charging and discharging.

Fourthly, because the physical property condition 3 is satisfied, in the positive electrode active material layer 21B, the abundance of Al atoms is appropriately smaller at the inner part (the position P2) than at the surface (the position P1). More specifically, the abundance of Al decreases gradually, not abruptly, from the surface (the position P1) toward the inner part (the position P2). In this case, in the positive electrode active material layer 21B, an advantage related to a first action based on the physical property condition 1 described above and an advantage related to a second action based on the physical property condition 2 described above are achieved in balance. This prevents a trade-off relationship in which achieving one of the advantages results in failing to achieve the other, in contrast to a case where the physical property condition 3 is not satisfied. Accordingly, both of the two advantages are effectively achievable.

By virtue of the foregoing, unlike in a case where not all of the physical property conditions 1 to 3 are satisfied, the decrease in discharge capacity and the gas generation are suppressed even upon repeated charging and discharging, and the lithium-ion entering and exiting characteristic improves not only at the initial cycle of charging and discharging but also at the subsequent cycles of charging and discharging, while a high energy density is obtained. This makes it possible to achieve a superior battery characteristic.

In this case, in particular, using coprecipitation and firing including a single firing process as the method of manufacturing the positive electrode active material allows substantially all of the physical property conditions 1 to 3 to be satisfied, which makes it possible to achieve an improved battery characteristic, unlike in a case of using coprecipitation and firing including two firing processes.

Specifically, as will be described in detail later in Examples, in the case of using coprecipitation and firing including two firing processes, the abundance of Al atoms in the positive electrode active material layer 21B becomes smaller at the inner part (the position P2) than at the surface (the position P1), as in the case of using coprecipitation and firing including a single firing process. However, the abundance of Al atoms excessively increases at the surface (the position P1) and excessively decreases at the inner part (the position P2), which results in a failure to satisfy the physical property condition 1 and a failure to satisfy the physical property condition 2. Otherwise, the abundance of Al atoms abruptly decreases at the inner part (the position P2) relative to that at the surface (the position P1), which results in a failure to satisfy the physical property condition 3. Accordingly, not all of the physical property conditions 1 to 3 are satisfied. This results in the trade-off relationship described above, thus making it difficult to achieve an improved battery characteristic.

In contrast, in the case of using coprecipitation and firing including a single firing process, the abundance of Al atoms in the positive electrode active material layer 21B appropriately increases at the surface (the position P1) and appropriately decreases at the inner part (the position P2), unlike in the case of using coprecipitation and firing including two firing processes. This allows both the physical property conditions 1 and 2 to be satisfied. Moreover, the abundance of Al atoms gradually decreases from the surface (the position P1) toward the inner part (the position P2), which allows the physical property condition 3 to be satisfied. All of the physical property conditions 1 to 3 are thus satisfied. This overcomes the trade-off relationship described above, making it possible to achieve an improved battery characteristic.

In addition, d in Formula (1) may satisfy d>0, and the lithium-nickel composite oxide may thus include the additional element M as a constituent element. This makes it easier for lithium ions to smoothly enter and exit the positive electrode active material (the lithium-nickel composite oxide) at the time of charging and discharging. Accordingly, it is possible to achieve higher effects.

Further, the secondary battery may include the outer package film 10 having flexibility. Also in a case where the flexible outer package film 10 is used which causes deformation (swelling) to be visually recognized easily, the swelling of the secondary battery is effectively suppressed. Accordingly, it is possible to achieve higher effects.

The electrolytic solution may include the multi-nitrile compound. This further prevents the secondary battery from easily swelling. Therefore, it is possible to achieve higher effects. In this case, the content of the multi-nitrile compound in the electrolytic solution may be within a range from 0.5 wt % to 3.0 wt % both inclusive. This sufficiently prevents the secondary battery from easily swelling. Therefore, it is possible to achieve further higher effects.

Further, the secondary battery may include a lithium-ion secondary battery. This makes it possible to obtain a sufficient battery capacity stably through the use of insertion and extraction of lithium. Accordingly, it is possible to achieve higher effects.

In addition, according to the positive electrode 21, the positive electrode active material layer 21B includes the lithium-nickel composite oxide of the layered rock-salt type as the positive electrode active material, and all of the physical property conditions 1 to 3 are satisfied regarding the analysis result (the concentration ratios X and Y and the relative ratio Z) on the positive electrode active material layer 21B obtained by XPS. Accordingly, for the reasons described above, it is possible for the secondary battery including the positive electrode 21 to achieve a superior battery characteristic.

Next, a description is given of modifications of the above-described secondary battery according to an embodiment. The configuration of the secondary battery is appropriately modifiable as described below. Note that any two or more of the following series of modifications may be combined with each other.

The separator 23 which is a porous film is used. However, although not specifically illustrated here, a separator of a stacked type including a polymer compound layer may be used instead of the separator 23 which is the porous film.

Specifically, the separator of the stacked type includes a porous film having two opposed surfaces, and the polymer compound layer disposed on one of or each of the two opposed surfaces of the porous film. A reason for this is that adherence of the separator to each of the positive electrode 21 and the negative electrode 22 improves to suppress the occurrence of misalignment of the battery device 20 (irregular winding of each of the positive electrode 21, the negative electrode 22, and the separator). This helps to prevent the secondary battery from easily swelling even if, for example, the decomposition reaction of the electrolytic solution occurs. The polymer compound layer includes a polymer compound such as polyvinylidene difluoride. A reason for this is that the polymer compound such as polyvinylidene difluoride has superior physical strength and is electrochemically stable.

Note that the porous film, the polymer compound layer, or both may each include one or more kinds of insulating particles. A reason for this is that such insulating particles dissipate heat upon heat generation by the secondary battery, thus improving safety or heat resistance of the secondary battery. Examples of the insulating particles include inorganic particles and resin particles. Specific examples of the inorganic particles include particles of: aluminum oxide, aluminum nitride, boehmite, silicon oxide, titanium oxide, magnesium oxide, and zirconium oxide. Specific examples of the resin particles include particles of acrylic resin and particles of styrene resin.

In a case of fabricating the separator of the stacked type, a precursor solution including, without limitation, the polymer compound and an organic solvent, is prepared and thereafter the precursor solution is applied on one of or each of the two opposed surfaces of the porous film. In this case, the insulating particles may be added to the precursor solution on an as-needed basis.

Also in the case where the separator of the stacked type is used, lithium ions are movable between the positive electrode 21 and the negative electrode 22. Accordingly, it is possible to achieve similar effects.

The electrolytic solution which is a liquid electrolyte is used. However, although not specifically illustrated here, an electrolyte layer which is a gel electrolyte may be used instead of the electrolytic solution.

In the battery device 20 including the electrolyte layer, the positive electrode 21 and the negative electrode 22 are stacked on each other with the separator 23 and the electrolyte layer interposed therebetween, and the stack of the positive electrode 21, the negative electrode 22, the separator 23, and the electrolyte layer is wound. The electrolyte layer is interposed between the positive electrode 21 and the separator 23, and between the negative electrode 22 and the separator 23.

Specifically, the electrolyte layer includes a polymer compound together with the electrolytic solution. The electrolytic solution is held by the polymer compound in the electrolyte layer. A reason for this is that liquid leakage is prevented. The configuration of the electrolytic solution is as described above. The polymer compound includes, for example, polyvinylidene difluoride. In a case of forming the electrolyte layer, a precursor solution including, without limitation, the electrolytic solution, the polymer compound, and an organic solvent is prepared and thereafter the precursor solution is applied on one side or both sides of the positive electrode 21 and one side or both sides of the negative electrode 22.

Also in the case where the electrolyte layer is used, lithium ions are movable between the positive electrode 21 and the negative electrode 22 via the electrolyte layer. Accordingly, it is possible to achieve similar effects.

Next, a description is given of applications (application examples) of the above-described secondary battery according to an embodiment.

The applications of the secondary battery are not particularly limited as long as they are, for example, machines, equipment, instruments, apparatuses, or systems (an assembly of a plurality of pieces of equipment, for example) in which the secondary battery is usable mainly as a driving power source, an electric power storage source for electric power accumulation, or any other source. The secondary battery used as a power source may serve as a main power source or an auxiliary power source. The main power source is preferentially used regardless of the presence of any other power source. The auxiliary power source may be used in place of the main power source, or may be switched from the main power source on an as-needed basis. In a case where the secondary battery is used as the auxiliary power source, the kind of the main power source is not limited to the secondary battery.

Specific examples of the applications of the secondary battery include: electronic equipment including portable electronic equipment; portable life appliances; apparatuses for data storage; electric power tools; battery packs to be mounted as detachable power sources on, for example, laptop personal computers; medical electronic equipment; electric vehicles; and electric power storage systems. Examples of the electronic equipment include video cameras, digital still cameras, mobile phones, laptop personal computers, cordless phones, headphone stereos, portable radios, portable televisions, and portable information terminals. Examples of the portable life appliances include electric shavers. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include home battery systems for accumulation of electric power for a situation such as emergency. In these applications, one secondary battery or a plurality of secondary batteries may be used.

In particular, the battery pack is effectively applied to relatively large-sized equipment, etc., including an electric vehicle, an electric power storage system, and an electric power tool. The battery pack may include a single battery, or may include an assembled battery. The electric vehicle is a vehicle that operates (travels) using the secondary battery as a driving power source, and may be an automobile that is additionally provided with a driving source other than the secondary battery as described above, such as a hybrid automobile. The electric power storage system is a system that uses the secondary battery as an electric power storage source. An electric power storage system for home use accumulates electric power in the secondary battery which is an electric power storage source, and the accumulated electric power may thus be utilized for using, for example, home appliances.

One of application examples of the secondary battery will now be described in detail. The configuration of the application example described below is merely an example, and is appropriately modifiable.

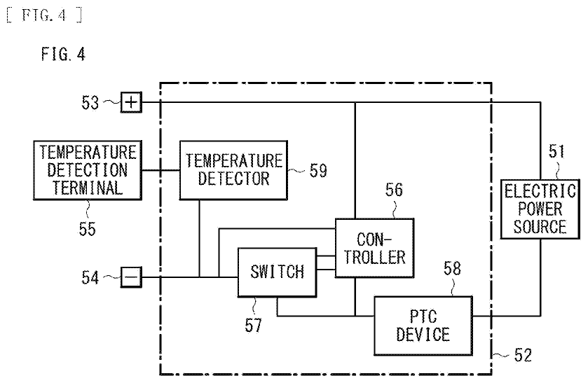

FIG. 4 illustrates a block configuration of a battery pack. The battery pack described here is a simple battery pack (a so-called soft pack) including one secondary battery, and is to be mounted on, for example, electronic equipment typified by a smartphone.

As illustrated in FIG. 4, the battery pack includes an electric power source 51 and a circuit board 52. The circuit board 52 is coupled to the electric power source 51, and includes a positive electrode terminal 53, a negative electrode terminal 54, and a temperature detection terminal 55 (a so-called T terminal).

The electric power source 51 includes one secondary battery. The secondary battery has a positive electrode lead coupled to the positive electrode terminal 53 and a negative electrode lead coupled to the negative electrode terminal 54. The electric power source 51 is couplable to outside via the positive electrode terminal 53 and the negative electrode terminal 54, and is thus chargeable and dischargeable via the positive electrode terminal 53 and the negative electrode terminal 54. The circuit board 52 includes a controller 56, a switch 57, a thermosensitive resistive device (a positive temperature coefficient (PTC) device) 58, and a temperature detector 59. However, the PTC device 58 may be omitted.

The controller 56 includes, for example, a central processing unit (CPU) and a memory, and controls an overall operation of the battery pack. The controller 56 detects and controls a use state of the electric power source 51 on an as-needed basis.

If a voltage of the electric power source 51 (the secondary battery) reaches an overcharge detection voltage or an overdischarge detection voltage, the controller 56 turns off the switch 57. This prevents a charging current from flowing into a current path of the electric power source 51. In addition, if a large current flows upon charging or discharging, the controller 56 turns off the switch 57 to block the charging current. The overcharge detection voltage and the overdischarge detection voltage are not particularly limited. For example, the overcharge detection voltage is 4.2 V±0.05 V and the overdischarge detection voltage is 2.4 V±0.1 V.

The switch 57 includes, for example, a charge control switch, a discharge control switch, a charging diode, and a discharging diode. The switch 57 performs switching between coupling and decoupling between the electric power source 51 and external equipment in accordance with an instruction from the controller 56. The switch 57 includes, for example, a metal-oxide-semiconductor field-effect transistor (MOSFET). The charging and discharging currents are detected on the basis of an ON-resistance of the switch 57.

The temperature detector 59 includes a temperature detection device such as a thermistor. The temperature detector 59 measures a temperature of the electric power source 51 using the temperature detection terminal 55, and outputs a result of the temperature measurement to the controller 56. The result of the temperature measurement to be obtained by the temperature detector 59 is used, for example, in a case where the controller 56 performs charge/discharge control upon abnormal heat generation or in a case where the controller 56 performs a correction process upon calculating a remaining capacity.

### EXAMPLES

A description is given of Examples of the present technology according to an embodiment.

### Examples 1 to 8 and Comparative Examples 9 to 15

As described below, positive electrode active materials were manufactured, and secondary batteries were manufactured using the positive electrode active materials, following which the secondary batteries were each evaluated for a battery characteristic.

### [Manufacture of Positive Electrode Active Materials in Examples 1 to 8 and Comparative Examples 9 to 14]

The positive electrode active material (the lithium-nickel composite oxide) was manufactured by, as the manufacturing method, coprecipitation and firing including a single firing process, in accordance with a procedure described below.

First, as raw materials, a nickel compound (nickel sulfate (NiSO₄)) in a powder form and a cobalt compound (cobalt sulfate (CoSO₄)) in a powder form were prepared. Thereafter, the nickel compound and the cobalt compound were mixed with each other to thereby obtain a mixture. In this case, the mixture ratio between the nickel compound and the cobalt compound was adjusted to set the mixture ratio (molar ratio) between Ni and Co to 85.4:14.6. The mixture ratio between the nickel compound and the cobalt compound was varied by varying the mixture ratio (molar ratio) of Co depending on the mixture ratio (molar ratio) of Ni.

Thereafter, the mixture was put into an aqueous solvent (pure water), following which the aqueous solvent was stirred to thereby obtain a mixture aqueous solution.

Thereafter, while stirring the mixture aqueous solution, alkali compounds (sodium hydroxide (NaOH) and ammonium hydroxide (NH₄OH)) were added to the mixture aqueous solution, i.e. coprecipitation was performed. A precipitate in a form of particles was thereby generated in the mixture aqueous solution. Thus, a precursor (secondary particles of a nickel-cobalt composite coprecipitated hydroxide) was obtained. The composition of the precursor was as listed in Table 1. In this case, an average particle size of the secondary particles was controlled in order to finally obtain secondary particles of the positive electrode active material having two different average particle sizes (median diameters D50 (μm)), that is, secondary particles of the positive electrode active material of the bi-model design including large-sized particles and small-sized particles. Two kinds of secondary particles having respective different average particle sizes were thereby formed.

Thereafter, as other raw materials, a lithium compound (lithium hydroxide monohydrate (LiOH.H₂O)) in a powder form and an aluminum compound (aluminum hydroxide (Al(OH)₃)) in a powder form were prepared.

Thereafter, the precursor, the aluminum compound, and the lithium compound were mixed with each other to thereby obtain a precursor mixture. In this case, a mixture ratio between the precursor and the aluminum compound was adjusted to set a mixture ratio (molar ratio) between Ni, Co, and Al to 82.0:14.0:4.0, and an addition amount (wt %) of the aluminum compound to the precursor was set to 1.12 wt %. In addition, a mixture ratio of the precursor and the aluminum compound to the lithium compound was adjusted to set a mixture ratio (molar ratio) of Ni, Co, and Al to Li to 103:100. Note that the mixture ratio between the precursor and the aluminum compound was varied by varying the mixture ratio (molar ratio) of Ni and Co depending on the mixture ratio (molar ratio) of Al. In addition, the mixture ratio of the precursor and the aluminum compound to the lithium compound was varied by varying the mixture ratio (molar ratio) of Ni, Co, and Al depending on the mixture ratio (molar ratio) of Li.

The “Addition timing” column in Table 1 indicates timing when the aluminum compound was added in the course of manufacturing the positive electrode active material. “After coprecipitation” indicates that the aluminum compound was added to the precursor after the precursor was obtained by coprecipitation, before performing a firing process to be described later.

Lastly, the precursor mixture was fired in an oxygen atmosphere. The firing temperature (° C.) was as listed in Table 1. Thus, the lithium-nickel composite oxide of the layered rock-salt type represented by Formula (1) in a powder form was synthesized.

The “Number of times of firing” column in Table 1 indicates the number of firing processes performed in the course of manufacturing the positive electrode active material. Here, the firing process was performed after the precursor was formed by coprecipitation. The number of times of firing was thus once.

In this manner, the positive electrode active material (the lithium-nickel composite oxide) was obtained. The composition and the NC ratio of the lithium-nickel composite oxide were as listed in Table 2.

In the case of manufacturing the positive electrode active material, the lithium-nickel composite oxide including, as a constituent element, manganese which is the additional element M was also synthesized in accordance with a similar procedure except that a manganese compound (manganese sulfate (MnSO₄)) in a powder form was further prepared as still another raw material, following which the manganese compound was further mixed with the precursor to thereby obtain the precursor mixture.

The “Additional element M” column in Table 2 indicates the presence or absence of the additional element M, and indicates, in a case where the lithium-nickel composite oxide included the additional element M as a constituent element, the kind of the additional element M.

### [Manufacture of Positive Electrode Active Material in Comparative Example 15]

For comparison, the positive electrode active material (the lithium-nickel composite oxide) was manufactured by, as the manufacturing method, coprecipitation and firing including two firing processes, instead of coprecipitation and firing including a single firing process, in accordance with a procedure described below.

In this case, first, the precursor (the secondary particles of the nickel-cobalt composite coprecipitated hydroxide) was obtained by coprecipitation in accordance with the procedure described above. Thereafter, a mixture of the precursor and the lithium compound (lithium hydroxide monohydrate) in a powder form was obtained, following which the mixture was fired (a first firing process). The mixture ratio (molar ratio) between the precursor and the lithium compound was as described above, and the firing temperature (° C.) in the first firing process was as listed in Table 1. Thus, a composite oxide in a powder form was obtained as a fired body.

Thereafter, a mixture of the composite oxide and the aluminum compound (aluminum hydroxide) in a powder form was obtained, following which the mixture was fired (a second firing process) in an oxygen atmosphere. In this case, an addition amount of the aluminum compound to the composite oxide was set to 0.41 wt %. The firing temperature (° C.) in the second firing process was as listed in Table 1. In this manner, a lithium-nickel composite oxide (a lithium nickel cobalt oxide with a surface covered with Al) of the layered rock-salt type in a powder form was synthesized. Thus, the positive electrode active material was obtained. The composition and the NC ratio of the positive electrode active material were as listed in Table 2.

Here, the aluminum compound was added after the first firing process was performed, before performing the second firing process. The addition timing of the aluminum compound was thus after the first firing, as indicated in the “Addition timing” column in Table 1. Here, two firing processes were performed as the method of manufacturing the positive electrode active material, and the number of times of firing was thus twice, as indicated in the “Number of times of firing” column in Table 1.

TABLE 1

| | | | Aluminum compound | | Firing process | |
|---|---|---|---|---|---|---|
| | | | | Addition | Number of | Firing |
| | Manufacturing | Precursor | Addition | amount | times of | temperature |
| | method | Composition | timing | (wt %) | firing | (° C.) |
| Example 1 | Coprecipitation + | (Ni_{0.854}Co_{0.146}) (OH)₂ | After | 1.12 | 1 | 700 |
| Example 2 | firing | (Ni_{0.854}Co_{0.146}) (OH)₂ | coprecipitation | 1.41 | | 700 |
| Example 3 | | (Ni_{0.854}Co_{0.146}) (OH)₂ | | 0.41 | | 700 |
| Example 4 | | (Ni_{0.854}Co_{0.146}) (OH)₂ | | 1.12 | | 650 |
| Example 5 | | (Ni_{0.854}Co_{0.146}) (OH)₂ | | 1.12 | | 850 |
| Example 6 | | (Ni_{0.812}Co_{0.188}) (OH)₂ | | 1.12 | | 700 |
| Example 7 | | (Ni_{0.937}Co_{0.063}) (OH)₂ | | 1.12 | | 700 |
| Example 8 | | (Ni_{0.833}Co_{0.083}Mn_{0.083}) (OH)₂ | | 1.12 | | 700 |
| Comparative | Coprecipitation + | (Ni_{0.854}Co_{0.146}) (OH)₂ | After | 1.56 | 1 | 700 |
| example 9 | firing | | coprecipitation | | | |
| Comparative | | (Ni_{0.854}Co_{0.146}) (OH)₂ | | 0.27 | | 700 |
| example 10 | | | | | | |
| Comparative | | (Ni_{0.854}Co_{0.146}) (OH)₂ | | 1.12 | | 600 |
| example 11 | | | | | | |
| Comparative | | (Ni_{0.854}Co_{0.146}) (OH)₂ | | 1.12 | | 900 |
| example 12 | | | | | | |
| Comparative | | (Ni_{0.781}Co_{0.219}) (OH)₂ | | 1.12 | | 700 |
| example 13 | | | | | | |
| Comparative | | (Ni_{0.969}Co_{0.031}) (OH)₂ | | 1.12 | | 700 |
| example 14 | | | | | | |
| Comparative | | (Ni_{0.854}Co_{0.146}) (OH)₂ | After first | 0.41 | 2 | First: 700 |
| example 15 | | | firing | | | Second: 650 |

TABLE 2

| | | | | Positive electrode | | | | | | |
|---|---|---|---|---|---|---|---|---|---|---|
| | | | | active material layer | | | | | | |
| | Lithium-nickel composite oxide | | | Concen- | Concen- | | Initial | Cycle | Load | |
| | | NC | Additional | tration | tration | Relative | capacity | retention | retention | Swelling |
| | Composition | ratio | element M | ratio X | ratio Y | ratio Z | (—) | rate (%) | rate (%) | rate (—) |
| Example 1 | LiNi_{0.820}Co_{0.140}Al_{0.040}O₂ | 5.86 | — | 0.51 | 0.27 | 1.90 | 100 | 90 | 78 | 100 |
| Example 2 | LiNi_{0.811}Co_{0.139}Al_{0.050}O₂ | 5.83 | — | 0.70 | 0.37 | 1.87 | 99 | 94 | 75 | 90 |
| Example 3 | LiNi_{0.841}Co_{0.144}Al_{0.015}O₂ | 5.84 | — | 0.30 | 0.16 | 1.91 | 102 | 85 | 80 | 110 |
| Example 4 | LiNi_{0.820}Co_{0.140}Al_{0.040}O₂ | 5.86 | — | 0.57 | 0.23 | 2.52 | 97 | 92 | 79 | 101 |
| Example 5 | LiNi_{0.820}Co_{0.140}Al_{0.040}O₂ | 5.86 | — | 0.43 | 0.33 | 1.30 | 100 | 88 | 75 | 100 |
| Example 6 | LiNi_{0.780}Co_{0.180}Al_{0.040}O₂ | 4.33 | — | 0.52 | 0.28 | 1.89 | 96 | 92 | 77 | 100 |
| Example 7 | LiNi_{0.900}Co_{0.060}Al_{0.040}O₂ | 15.0 | — | 0.50 | 0.27 | 1.88 | 106 | 85 | 79 | 100 |
| Example 8 | LiNi_{0.800}Co_{0.080}Al_{0.040}Mn_{0.080}O₂ | 10.0 | Mn | 0.51 | 0.27 | 1.89 | 102 | 90 | 76 | 100 |
| Comparative | LiNi_{0.807}Co_{0.138}Al_{0.055}O₂ | 5.85 | — | 0.73 | 0.39 | 1.85 | 98 | 91 | 74 | 85 |
| example 9 | | | | | | | | | | |
| Comparative | LiNi_{0.846}Co_{0.144}Al_{0.010}O₂ | 5.88 | — | 0.28 | 0.14 | 1.94 | 103 | 83 | 81 | 113 |
| example 10 | | | | | | | | | | |
| Comparative | LiNi_{0.820}Co_{0.140}Al_{0.040}O₂ | 5.86 | — | 0.60 | 0.17 | 3.55 | 95 | 88 | 75 | 102 |
| example 11 | | | | | | | | | | |
| Comparative | LiNi_{0.820}Co_{0.140}Al_{0.040}O₂ | 5.86 | — | 0.40 | 0.32 | 1.25 | 100 | 85 | 74 | 100 |
| example 12 | | | | | | | | | | |
| Comparative | LiNi_{0.750}Co_{0.210}Al_{0.040}O₂ | 3.57 | — | 0.53 | 0.28 | 1.89 | 95 | 93 | 78 | 100 |
| example 13 | | | | | | | | | | |
| Comparative | LiNi_{0.930}Co_{0.030}Al_{0.040}O₂ | 31.0 | — | 0.49 | 0.26 | 1.91 | 108 | 81 | 79 | 100 |
| example 14 | | | | | | | | | | |
| Comparative | LiNi_{0.841}Co_{0.144}Al_{0.015}O₂ | 5.84 | — | 0.60 | 0.15 | 4.00 | 102 | 84 | 73 | 105 |
| example 15 | | | | | | | | | | |

### [Manufacture of Secondary Batteries in Examples 1 to 8 and Comparative Examples 9 to 15]

The secondary batteries (lithium-ion secondary batteries) of the laminated-film type illustrated in FIGS. 1 to 3 were manufactured in accordance with a procedure described below.

### (Fabrication of Positive Electrode)

First, 95.5 parts by mass of the positive electrode active material, 1.9 parts by mass of the positive electrode binder (polyvinylidene difluoride), 2.5 parts by mass of the positive electrode conductor (carbon black), and 0.1 parts by mass of a dispersant (polyvinylpyrrolidone) were mixed with each other to thereby obtain a positive electrode mixture. Thereafter, the positive electrode mixture was put into an organic solvent (N-methyl-2-pyrrolidone), following which the organic solvent was stirred to thereby prepare a paste positive electrode mixture slurry. Thereafter, the positive electrode mixture slurry was applied on each of the two opposed surfaces of the positive electrode current collector 21A (a band-shaped aluminum foil having a thickness of 15 μm) by means of a coating apparatus, following which the applied positive electrode mixture slurry was dried to thereby form the positive electrode active material layer 21B. Lastly, the positive electrode active material layer 21B was compression-molded by means of a roll pressing machine. Thus, the positive electrode 21 was fabricated.

The result obtained by analyzing the physical property (the concentration ratios X and Y and the relative ratio Z) of the positive electrode 21 (the positive electrode active material layer 21B) by XPS was as presented in Table 2. The procedure of analyzing the positive electrode active material layer 21B by XPS was as described above.

### (Fabrication of Negative Electrode)

First, 90 parts by mass of the negative electrode active material (graphite) and 10 parts by mass of the negative electrode binder (polyvinylidene difluoride) were mixed with each other to thereby obtain a negative electrode mixture. Thereafter, the negative electrode mixture was put into an organic solvent (N-methyl-2-pyrrolidone), following which the organic solvent was stirred to thereby prepare a paste negative electrode mixture slurry. Thereafter, the negative electrode mixture slurry was applied on each of the two opposed surfaces of the negative electrode current collector 22A (a band-shaped copper foil having a thickness of 15 μm) by means of a coating apparatus, following which the applied negative electrode mixture slurry was dried to thereby form the negative electrode active material layer 22B. Lastly, the negative electrode active material layer 22B was compression-molded by means of a roll pressing machine. Thus, the negative electrode 22 was fabricated.

### (Preparation of Electrolytic Solution)

The electrolyte salt (lithium hexafluorophosphate (LiPF₆)) was added to the solvent (ethylene carbonate and ethyl methyl carbonate), following which the solvent was stirred. In this case, the mixture ratio (weight ratio) between ethylene carbonate and ethyl methyl carbonate in the solvent was set to 50:50, and the content of the electrolyte salt with respect to the solvent was set to 1 mol/kg. Thus, the electrolytic solution was prepared.

### (Assembly of Secondary Battery)

First, the positive electrode lead 31 (a band-shaped aluminum foil) was welded to the positive electrode 21 (the positive electrode current collector 21A), and the negative electrode lead 32 (a band-shaped copper foil) was welded to the negative electrode 22 (the negative electrode current collector 22A).

Thereafter, the positive electrode 21 and the negative electrode 22 were stacked on each other with the separator 23 (a fine-porous polyethylene film having a thickness of 25 μm) interposed therebetween, following which the stack of the positive electrode 21, the negative electrode 22, and the separator 23 was wound to thereby fabricate the wound body. Thereafter, the wound body was pressed by means of a pressing machine to thereby shape the wound body into an elongated shape.

Thereafter, the outer package film 10 was folded in such a manner as to sandwich the wound body placed in the depression part 10U, following which the outer edges of two sides of the outer package film 10 (the fusion-bonding layer) were thermal-fusion-bonded to each other to thereby allow the wound body to be contained inside the pouch-shaped outer package film 10. As the outer package film 10, an aluminum laminated film was used in which the fusion-bonding layer (a polypropylene film having a thickness of 30 μm), the metal layer (an aluminum foil having a thickness of 40 μm), and the surface protective layer (a nylon film having a thickness of 25 μm) were stacked in this order from the inner side.

Lastly, the electrolytic solution was injected into the pouch-shaped outer package film 10, following which the outer edges of the remaining one side of the outer package film 10 (the fusion-bonding layer) were thermal-fusion-bonded to each other in a reduced-pressure environment. In this case, the sealing film 41 (a polypropylene film having a thickness of 5 μm) was interposed between the outer package film 10 and the positive electrode lead 31, and the sealing film 42 (a polypropylene film having a thickness of 5 μm) was interposed between the outer package film 10 and the negative electrode lead 32. The wound body was thereby impregnated with the electrolytic solution. In this manner, the battery device 20, i.e., the wound electrode body, was fabricated, and the battery device 20 was sealed in the pouch-shaped outer package film 10. Thus, the secondary battery was assembled.

### (Stabilization of Secondary Battery)

The secondary battery was charged and discharged for one cycle in an ambient temperature environment (25° C. in temperature). Upon the charging, the secondary battery was charged with a constant current of 0.1 C until a voltage reached 4.2 V, and was thereafter charged with a constant voltage of that value of 4.2 V until a current reached 0.005 C. Upon the discharging, the secondary battery was discharged with a constant current of 0.1 C until the voltage reached 2.5 V. Note that 0.1 C is a value of a current that causes a battery capacity (a theoretical capacity) to be completely discharged in 10 hours, and 0.005 C is a value of a current that causes the battery capacity to be completely discharged in 200 hours.

As a result, a film was formed on the surface of, for example, the negative electrode 22. The state of the secondary battery was thereby stabilized. Thus, the secondary battery of the laminated-film type was completed.

The secondary batteries were each evaluated for a battery characteristic (an initial capacity characteristic, a cyclability characteristic, a load characteristic, and a swelling characteristic). The results of the evaluation are presented in Table 2.

The secondary battery was charged and discharged for one cycle in the ambient temperature environment to measure the discharge capacity (an initial capacity). Charging and discharging conditions were similar to those in stabilizing the secondary battery described above. Values of the initial capacity listed in Table 2 are normalized values each obtained with respect to the value of the initial capacity of Example 1 assumed as 100.

First, the secondary battery was charged and discharged in a high-temperature environment (60° C. in temperature) to thereby measure the discharge capacity (a first-cycle discharge capacity). Thereafter, the secondary battery was repeatedly charged and discharged in the same environment until the total number of cycles reached 100 to thereby measure the discharge capacity (a 100th-cycle discharge capacity). Charging and discharging conditions were similar to those in stabilizing the secondary battery described above. Lastly, the following was calculated: cycle retention rate (%)=(100th-cycle discharge capacity/first-cycle discharge capacity)×100.

First, the secondary battery was charged and discharged in the ambient temperature environment to thereby measure the discharge capacity (a first-cycle discharge capacity). Charging and discharging conditions were similar to those in stabilizing the secondary battery described above, except that the current at the time of charging and the current at the time of discharging were each changed from 0.1 C to 0.2 C. Thereafter, the secondary battery was charged and discharged again in the same environment to thereby measure the discharge capacity (a second-cycle discharge capacity). Charging and discharging conditions were similar to those in stabilizing the secondary battery described above, except that the current at the time of discharging was changed from 0.1 C to 10 C. Note that 0.2 C is a value of a current that causes the battery capacity to be completely discharged in 5 hours, and 10 C is a value of a current that causes the battery capacity to be completely discharged in 0.1 hours. Lastly, the following was calculated: load retention rate (%)=(second-cycle discharge capacity (current at time of discharging: 10 C)/first-cycle discharge capacity (current at time of discharging: 0.2 C))×100.

First, the secondary battery was charged in an ambient temperature environment, following which a volume (a pre-storage volume) of the secondary battery was measured by the Archimedes' method. Charging and discharging conditions were similar to those for stabilizing the secondary battery described above. Thereafter, the secondary battery was stored in a high-temperature environment (storage time of 1 week), following which the volume (a post-storage volume) of the secondary battery was measured by the Archimedes' method again. Lastly, a swelling rate (%) was calculated as follows: (post-storage volume/pre-storage volume)×100. Note that the values of the swelling rate listed in Table 2 are normalized values each obtained with respect to the swelling rate of Example 1 assumed as 100.

As indicated in Table 2, the battery characteristic of the secondary battery varied depending on the analysis result on the positive electrode active material layer 21B obtained by XPS, that is, the physical property of the positive electrode active material layer 21B.

Specifically, in a case where not all of the physical property conditions 1 to 3 were satisfied (Comparative examples 9 to 15), there was a trade-off relationship in which improvement in any of the initial capacity, the cycle retention rate, the load retention rate, and the swelling rate resulted in deterioration of the other(s). Thus, it was difficult to improve each of the initial capacity, the cycle retention rate, the load retention rate, and the swelling rate.

In particular, in a case where the positive electrode active material (the lithium-nickel composite oxide) was manufactured by coprecipitation and firing including a single firing process (Comparative example 15), the relative ratio Z excessively increased, which resulted in the trade-off relationship described above.

In contrast, in a case where all of the physical property conditions 1 to 3 were satisfied (Examples 1 to 8), the trade-off relationship described above was overcome, and it was thus possible to improve each of the initial capacity, the cycle retention rate, the load retention rate, and the swelling rate.

In this case, if the positive electrode active material (the lithium-nickel composite oxide) included the additional element M (Mn) as a constituent element, in particular, the initial capacity increased whereas the load retention rate slightly decreased, as compared with a case where the lithium-nickel composite oxide did not include the additional element M (Mn) as a constituent element. Further, the swelling rate was sufficiently reduced even if the flexible outer package film 10 was used which causes deformation (swelling) to be visually recognized easily.

In accordance with a similar procedure except that the composition of the electrolytic solution was changed, positive electrode active materials were manufactured, and secondary batteries were manufactured, following which the secondary batteries were each evaluated for a battery characteristic (the initial capacity characteristic, the cyclability characteristic, the load characteristic, and the swelling characteristic), as given in Tables 3 to 6.

Each of Tables 3 to 6 indicates only some of the constitutional conditions of the lithium-nickel composite oxide given in Table 2. Specifically, only the composition is indicated without the NC ratio and the additional element M being indicated.

In a preparation process of the electrolytic solution, a similar procedure was used except that the electrolyte salt was added to the solvent, following which the multi-nitrile compound was further added to the solvent. Here, the dinitrile compound or the trinitrile compound was used as the multi-nitrile compound, and the dinitrile compound and the trinitrile compound were used in combination on an as-needed basis.

Specifically, used as the dinitrile compounds were succinonitrile (SN), glutaronitrile (GN), adiponitrile (AN), pimelonitrile (PN), suberonitrile (SUN), sebaconitrile (SEN), and ethylene glycol bis(propionitrile) ether (EGPNE). Used as the trinitrile compounds were 1,3,5-cyclohexanetricarbonitrile (CHTCN) and 1,3,6-hexanetricarbonitrile (HTCN).

A content (wt %) of the multi-nitrile compound in the electrolytic solution was as given in Tables 3 to 6.

TABLE 3

| | | Positive electrode | | | | | | | | |
|---|---|---|---|---|---|---|---|---|---|---|
| | | active material layer | | | Multi-nitrile | | | | | |
| | Lithium-nickel | Concen- | Concen- | | compound | | Initial | Cycle | Load | |
| | composite oxide | tration | tration | Relative | | Content | capacity | retention | retention | Swelling |
| | Composition | ratio X | ratio Y | ratio Z | Kind | (wt %) | (—) | rate (%) | rate (%) | rate (—) |
| Example 16 | LiNi_{0.820}Co_{0.140}Al_{0.040}O₂ | 0.51 | 0.27 | 1.90 | SN | 0.25 | 95 | 93 | 84 | 85 |
| Example 17 | | | | | | 0.50 | 94 | 92 | 82 | 78 |
| Example 18 | | | | | | 0.75 | 94 | 91 | 81 | 77 |
| Example 19 | | | | | | 1.00 | 92 | 90 | 80 | 75 |
| Example 20 | | | | | | 1.50 | 92 | 90 | 78 | 75 |
| Example 21 | | | | | | 2.00 | 92 | 88 | 77 | 72 |
| Example 22 | | | | | | 2.50 | 90 | 86 | 76 | 71 |
| Example 23 | | | | | | 3.00 | 89 | 85 | 75 | 70 |
| Example 24 | | | | | | 3.25 | 88 | 81 | 73 | 69 |
| Example 25 | LiNi_{0.811}Co_{0.139}Al_{0.050}O₂ | 0.70 | 0.37 | 1.87 | SN | 1.50 | 91 | 94 | 75 | 67 |
| Example 26 | LiNi_{0.841}Co_{0.144}A1_{0.015}O₂ | 0.30 | 0.16 | 1.91 | SN | 1.50 | 94 | 85 | 80 | 80 |
| Example 27 | LiNi_{0.820}Co_{0.140}Al_{0.040}O₂ | 0.57 | 0.23 | 2.52 | SN | 1.50 | 89 | 92 | 79 | 75 |
| Example 28 | LiNi_{0.820}Co_{0.140}Al_{0.040}O₂ | 0.43 | 0.33 | 1.30 | SN | 1.50 | 92 | 88 | 75 | 75 |
| Example 29 | LiNi_{0.780}Co_{0.180}Al_{0.040}O₂ | 0.52 | 0.28 | 1.89 | SN | 1.50 | 88 | 92 | 77 | 75 |
| Example 30 | LiNi_{0.900}Co_{0.060}Al_{0.040}O₂ | 0.50 | 0.27 | 1.88 | SN | 1.50 | 97 | 85 | 79 | 75 |
| Example 31 | LiNi_{0.800}Co_{0.080}Al_{0.040}Mn_{0.080}O₂ | 0.51 | 0.27 | 1.89 | SN | 1.50 | 94 | 90 | 76 | 75 |

TABLE 4

| | | Positive electrode | | | | | | | | |
|---|---|---|---|---|---|---|---|---|---|---|
| | | active material layer | | | Multi-nitrile | | | | | |
| | Lithium-nickel | Concen- | Concen- | | compound | | Initial | Cycle | Load | |
| | composite oxide | tration | tration | Relative | | Content | capacity | retention | retention | Swelling |
| | Composition | ratio X | ratio Y | ratio Z | Kind | (wt %) | (—) | rate (%) | rate (%) | rate (—) |
| Example 32 | LiNi_{0.820}Co_{0.140}Al_{0.040}O₂ | 0.51 | 0.27 | 1.90 | AN | 0.25 | 97 | 94 | 85 | 87 |
| Example 33 | | | | | | 0.50 | 95 | 92 | 84 | 80 |
| Example 34 | | | | | | 0.75 | 94 | 92 | 81 | 77 |
| Example 35 | | | | | | 1.00 | 94 | 90 | 80 | 76 |
| Example 36 | | | | | | 1.50 | 93 | 90 | 80 | 76 |
| Example 37 | | | | | | 2.00 | 92 | 89 | 78 | 75 |
| Example 38 | | | | | | 2.50 | 91 | 88 | 77 | 74 |
| Example 39 | | | | | | 3.00 | 89 | 86 | 76 | 72 |
| Example 40 | | | | | | 3.25 | 88 | 83 | 74 | 72 |
| Example 41 | LiNi_{0.820}Co_{0.140}Al_{0.040}O₂ | 0.51 | 0.27 | 1.90 | SN + AN | 0.125 + 0.125 | 95 | 92 | 84 | 84 |
| Example 42 | | | | | | 0.25 + 0.25 | 93 | 90 | 82 | 76 |
| Example 43 | | | | | | 0.50 + 0.50 | 91 | 89 | 81 | 71 |
| Example 44 | | | | | | 0.75 + 0.75 | 91 | 87 | 80 | 69 |

TABLE 5

| | | Positive electrode | | | | | | | | |
|---|---|---|---|---|---|---|---|---|---|---|
| | | active material layer | | | Multi-nitrile | | | | | |
| | Lithium-nickel | Concen- | Concen- | | compound | | Initial | Cycle | Load | |
| | composite oxide | tration | tration | Relative | | Content | capacity | retention | retention | Swelling |
| | Composition | ratio X | ratio Y | ratio Z | Kind | (wt %) | (—) | rate (%) | rate (%) | rate (—) |
| Example 45 | LiNi_{0.820}Co_{0.140}Al_{0.040}O₂ | | | | | 1.00 + 1.00 | 90 | 86 | 77 | 69 |
| Example 46 | | 0.51 | 0.27 | 1.90 | SN + AN | 1.50 + 1.50 | 88 | 82 | 75 | 67 |
| Example 47 | | | | | | 1.75 + 1.75 | 87 | 81 | 72 | 66 |
| Example 48 | LiNi_{0.820}Co_{0.140}Al_{0.040}O₂ | 0.51 | 0.27 | 1.90 | GN | 1.50 | 92 | 89 | 77 | 75 |
| Example 49 | LiNi_{0.820}Co_{0.140}Al_{0.040}O₂ | 0.51 | 0.27 | 1.90 | PN | 1.50 | 92 | 88 | 76 | 79 |
| Example 50 | LiNi_{0.820}Co_{0.140}Al_{0.040}O₂ | 0.51 | 0.27 | 1.90 | SUN | 1.50 | 91 | 87 | 76 | 80 |
| Example 51 | LiNi_{0.820}Co_{0.140}Al_{0.040}O₂ | 0.51 | 0.27 | 1.90 | SEN | 1.50 | 91 | 89 | 77 | 78 |
| Example 52 | LiNi_{0.820}Co_{0.140}Al_{0.040}O₂ | 0.51 | 0.27 | 1.90 | EPGNE | 1.50 | 90 | 88 | 76 | 76 |
| Example 53 | LiNi_{0.820}Co_{0.140}Al_{0.040}O₂ | 0.51 | 0.27 | 1.90 | CHTCN | 1.50 | 89 | 86 | 75 | 75 |
| Example 54 | LiNi_{0.820}Co_{0.140}Al_{0.040}O₂ | 0.51 | 0.27 | 1.90 | HTCN | 1.50 | 90 | 87 | 76 | 77 |

TABLE 6

| | | Positive electrode | | | | | | | | |
|---|---|---|---|---|---|---|---|---|---|---|
| | | active material layer | | | Multi-nitrile | | | | | |
| | Lithium-nickel | Concen- | Concen- | | compound | | Initial | Cycle | Load | |
| | composite oxide | tration | tration | Relative | | Content | capacity | retention | retention | Swelling |
| | Composition | ratio X | ratio Y | ratio Z | Kind | (wt %) | (—) | rate (%) | rate (%) | rate (—) |
| Comparative | LiNi_{0.807}Co_{0.138}Al_{0.055}O₂ | 0.73 | 0.39 | 1.85 | SN | 1.50 | 90 | 91 | 74 | 63 |
| example 55 | | | | | | | | | | |
| Comparative | LiNi_{0.846}Co_{0.144}Al_{0.010}O₂ | 0.28 | 0.14 | 1.94 | SN | 1.50 | 94 | 83 | 81 | 84 |
| example 56 | | | | | | | | | | |
| Comparative | LiNi_{0.820}Co_{0.140}Al_{0.040}O₂ | 0.60 | 0.17 | 3.55 | SN | 1.50 | 87 | 88 | 75 | 76 |
| example 57 | | | | | | | | | | |
| Comparative | LiNi_{0.820}Co_{0.140}Al_{0.040}O₂ | 0.40 | 0.32 | 1.25 | SN | 1.50 | 92 | 85 | 74 | 75 |
| example 58 | | | | | | | | | | |
| Comparative | LiNi_{0.750}Co_{0.210}Al_{0.040}O₂ | 0.53 | 0.28 | 1.89 | SN | 1.50 | 87 | 93 | 78 | 75 |
| example 59 | | | | | | | | | | |
| Comparative | LiNi_{0.930}Co_{0.030}Al_{0.040}O₂ | 0.49 | 0.26 | 1.91 | SN | 1.50 | 99 | 81 | 79 | 75 |
| example 60 | | | | | | | | | | |
| Comparative | LiNi_{0.841}Co_{0.144}A1_{0.015}O₂ | 0.60 | 0.15 | 4.00 | SN | 1.50 | 94 | 84 | 73 | 78 |
| example 61 | | | | | | | | | | |

As given in Tables 3 to 6, also in a case where the electrolytic solution included the multi-nitrile compound, results similar to those given in Table 2 were obtained. That is, the trade-off relationship was overcome in the cases (Examples 16 to 54) where all of the physical property conditions 1 to 3 were satisfied, unlike in the cases (Comparative examples 55 to 61) where not all of the physical property conditions 1 to 3 were satisfied. Therefore, it was possible to improve each of the initial capacity, the cyclability retention rate, the road retention rate, and the swelling rate.

In particular, in a case where all of the physical property conditions 1 to 3 were satisfied, an additional advantage was obtained. Specifically, in the cases (Examples 16 to 54) where the electrolytic solution included the multi-nitrile compound, the swelling rate was further decreased while the initial capacity, the cyclability retention rate, and the load retention rate were each maintained within an allowable range, as compared with the cases (Examples 1 to 8) where the electrolytic solution included no multi-nitrile compound. Further, in the cases (Examples 17 to 23 and 33 to 39) where the electrolytic solution included the multi-nitrile compound and where the content of the multi-nitrile compound in the electrolytic solution was within a range from 0.5 wt % to 3.0 wt % both inclusive, the swelling rate was further decreased while the initial capacity, the cyclability retention rate, and the load retention rate were each substantially maintained.

Based upon the results presented in Tables 2 to 6, in the case where the positive electrode active material layer 21B included the lithium-nickel composite oxide of the layered rock-salt type as the positive electrode active material, and where all of the physical property conditions 1 to 3 were satisfied regarding the analysis result (the concentration ratios X and Y and the relative ratio Z) on the positive electrode active material layer 21B obtained by XPS, the initial capacity characteristic, the cyclability characteristic, the load characteristic, and the swelling characteristic were each improved. Accordingly, the secondary battery achieved a superior battery characteristic.

Although the present technology has been described herein with reference to one or more embodiments including Examples, configurations of the present technology are not limited to such description and are modifiable in a variety of suitable ways.

For example, although the description has been given of the case where the secondary battery has a battery structure of the laminated-film type, the battery structure is not particularly limited. Accordingly, the battery structure of the secondary battery may be of, for example, a cylindrical type, a prismatic type, a coin type, or a button type.

Further, although the description has been given of the case where the battery device has a device structure of the wound type, the device structure of the battery device is not particularly limited. Accordingly, the device structure of the battery device may be of, for example, a stacked type in which the electrodes (the positive electrode and the negative electrode) are stacked, or a zigzag folded type in which the electrodes (the positive electrode and the negative electrode) are folded in a zigzag manner.

Further, although the description has been given of the case where the electrode reactant is lithium, the electrode reactant is not particularly limited. Specifically, the electrode reactant may be another alkali metal such as sodium or potassium, or may be an alkaline earth metal such as beryllium, magnesium, or calcium, as described above. In addition, the electrode reactant may be another light metal such as aluminum.

Further, the applications of the positive electrode described above are not limited to a secondary battery. The positive electrode may thus be applied to another electrochemical device such as a capacitor.

The effects described herein are mere examples, and effects of the present technology are therefore not limited to those described herein. Accordingly, the present technology may achieve any other suitable effect.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode including a positive electrode active material layer;
a negative electrode; and
an electrolytic solution, wherein
the positive electrode active material layer includes a lithium-nickel composite oxide of a layered rock-salt type represented by Formula (1) below,
according to an analysis of the positive electrode active material layer performed at a surface of the positive electrode active material layer by X-ray photoelectron spectroscopy, a ratio X of an atomic concentration of Al to an atomic concentration of Ni satisfies a condition represented by Expression (2) below,
according to an analysis of the positive electrode active material layer performed at an inner part at a depth of 100 nanometers of the positive electrode active material layer by the X-ray photoelectron spectroscopy, a ratio Y of the atomic concentration of Al to the atomic concentration of Ni satisfies a condition represented by Expression (3) below, and
a ratio Z of the ratio X to the ratio Y satisfies a condition represented by Expression (4) below,
LiₐNi_{1-b-c-d}Co_{b}Al_{c}M_{d}Oₑ (1)
where
M is at least one of Fe, Mn, Cu, Zn, Cr, V, Ti, Mg, or Zr, and
a, b, c, d, and e satisfy 0.8<a<1.2, 0.06≤b≤0.18, 0.015≤c≤0.05, 0≤d≤0.08, 0<e<3, 0.1≤(b+c+d)≤0.22, and 4.33≤(1-b-c-d)/b≤15.0,
0.30≤X≤0.70 (2)
0.16≤Y≤0.37 (3)
30≤Z≤2.52 (4).

2. The secondary battery according to claim 1, wherein d in Formula (1) above satisfies d>0.

3. The secondary battery according to claim 1, further comprising an outer package member having flexibility and containing the positive electrode, the negative electrode, and the electrolytic solution.

4. The secondary battery according to claim 1, wherein the electrolytic solution includes a multi-nitrile compound.

5. The secondary battery according to claim 4, wherein a content of the multi-nitrile compound in the electrolytic solution is greater than or equal to 0.5 weight percent and less than or equal to 3.0 weight percent.

6. The secondary battery according to claim 1, wherein the secondary battery comprises a lithium-ion secondary battery.

7. A positive electrode for a secondary battery, the positive electrode comprising
a positive electrode active material layer, wherein
the positive electrode active material layer includes a lithium-nickel composite oxide of a layered rock-salt type represented by Formula (1) below,
according to an analysis of the positive electrode active material layer performed at a surface of the positive electrode active material layer by X-ray photoelectron spectroscopy, a ratio X of an atomic concentration of Al to an atomic concentration of Ni satisfies a condition represented by Expression (2) below,
according to an analysis of the positive electrode active material layer performed at an inner part at a depth of 100 nanometers of the positive electrode active material layer by the X-ray photoelectron spectroscopy, a ratio Y of the atomic concentration of Al to the atomic concentration of Ni satisfies a condition represented by Expression (3) below,
a ratio Z of the ratio X to the ratio Y satisfies a condition represented by Expression (4) below,
LiₐNi_{1-b-c-d}Co_{b}Al_{c}M_{d}Oₑ (1)
where
M is at least one of Fe, Mn, Cu, Zn, Cr, V, Ti, Mg, or Zr, and
a, b, c, d, and e satisfy 0.8<a<1.2, 0.06≤b≤0.18, 0.015≤c≤0.05, 0≤d≤0.08, 0<e<3, 0.1≤(b+c+d)≤0.22, and 4.33≤(1-b-c-d)/b≤15.0,
0.30≤X≤0.70 (2)
0.16≤Y≤0.37 (3)
1.30≤Z≤2.52 (4).
